(19) United States
(12) Patent Application Publication
(10) Pub. No.: US 2013/0268426 A1
(43) Pub. Date: Oct. 10, 2013

(54) REMOTE COMMUNICATION TERMINAL FOR TRADING ON THE EXCHANGE MARKETS

(71) Applicants: Ilya Vladimirovich Kligman, St. Petersburg (RU); Sergey Vladimirovich Migalev, Rostov-na-Donu (RU)

(72) Inventors: Ilya Vladimirovich Kligman, St. Petersburg (RU); Sergey Vladimirovich Migalev, Rostov-na-Donu (RU)

(21) Appl. No.: 13/994,667

(22) PCT Filed: Dec. 30, 2010
(86) PCT No.: PCT/RU2010/000809

§ 371 Date: Jun. 14, 2013

(51) Int. Cl. G06Q 40/04

(52) U.S. Cl. CPC G06Q 40/04
USPC 705/37

(57) ABSTRACT

A terminal for trading on exchange markets, comprising a monitor and a keyboard (real or virtual), a device providing transfer of funds to user's account and withdrawal of funds from the user's account and/or money dispending, a device for remote connection configured to display a graphical interface with fields for displaying target information, connected to a control server for the user's account state. The device provides transfer of funds to/from the user's account and/or money dispensing, built into the terminal case, or located outside the case and connected to servers of exchange markets for displaying in fields of information about the current quotations, positions and calculation of profit and loss for each transaction, thus the specified unit also has a feature of displaying of positions and with a feature of input of the price for a rate (point) change and a position amount through the keyboard.

### CROSS-REFERENCE TO RELATED APPLICATIONS

The application is a National Phase of of PCT/RU2010/000809, filed on Dec. 30, 2010, incorporated herein by reference in its entirety.

### BACKGROUND OF THE INVENTION

The invention relates to the systems for assistance in financial transactions, providing fast trading and fast distribution of material reward as a result of trading.

Conventional art teaches an exchange trading system comprising of a computer; a plurality of information sets about tendering received by the computer, where each of the information sets about tendering describes trading session of the first trader; a plurality of information sets about quotas of the trading received by the computer, where each of the information sets about quotas of the trading describes trading held by the order of the second trader; a set of the preset acceptable parameters of trading and software features carried out by the computer to compare information sets about tendering with information sets about quotas of the trading and to define coincidences if information set about tendering and information set about quotas of the trading conform within a set of preset acceptable trading parameters (see RU Patent No. 2259586).

A disadvantage of the conventional systems is its complexity not only in hardware but also in insufficient functionality that excludes remote access to the trading of other persons who are not officially registered for participation in trading.

Conventional art also teaches remote communication terminal for trading on the exchange markets, comprising of a monitor and a push-button or touch keyboard or a touch monitor with a keyboard on a monitor screen, a payment card reader, a money input system, a device for remote connection in the form of a programming and computing unit having feature of graphic interface displaying with the fields for target information displaying, with the relevant control server for the user's account state, as well as a money output device. The programming and computing unit has a remote connection with servers of the exchange markets and information agencies for displaying in the specified fields of information about the current quotations, positions/positions and calculation of profit and loss for each transaction. The unit also has a feature of displaying of positions, with a feature of input of the price for a point change and a position amount through the keyboard and transfer of a premium to the account of a payment card holder or output of a premium through a money output device (RU Patent No. 64405, 2007).

The disadvantage of this solution is that there is restriction on the mode of money input: only a payment card is applied. At the moment, various payments mechanisms which can be used in the mode of a direct crediting of the trader account are being developed. Restriction for payment cards usage significantly narrows a group of potential users and does not give an opportunity to hold game sessions to those who use other financial mechanisms or have no possibility to register and use a credit card.

### DETAILED DESCRIPTION OF THE PREFERRED EMBODIMENTS

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The primary objective of the invention is implementation of the terminal for simple style trading. Such a terminal can also serve as gaming equipment and can be placed in game clubs, casinos and club-type entertainment places.

The terminal is operated according to the principles of FOREX international currency exchange market. To ensure normal operation of such a terminal, it is necessary to provide real time broadcasting of the currency market quotations for the trading tools on that terminal and to implement a profit calculation algorithm for transactions made by a client.

Quotations source can be both widely known information sources—Reuters, Bloomberg, Tenfore, as well trading centers providing access to trade operations on FOREX markets via the Internet.

Also, the transactions made through the terminal can be introduced, through one of the dealing centers, to the real market that makes such terminal not a gambling equipment but rather a remote terminal for the stock exchange transactions.

The present invention is focused on the technical result of cutting time for transactions through a use of various systems of input and movement of money funds.

The technical result is obtained by the fact that the remote communication terminal for trading on the exchange markets, comprising a monitor and a keyboard or a monitor with a keyboard on a monitor screen, a device providing transfer of funds to user's account and/or withdrawal of funds from the user's account and/or money output, a device for remote connection in the form of the programming and computing unit displaying of the graphic interface with the fields for showing target information, connected with the control server for the user's account state, a device providing transfer of funds to the user's account and/or withdrawal of funds from the user's account and/or money output, in a form of a unit built into the terminal case, or located outside the latter at a distance and connected to the programming and computing unit that has a remote connection with the servers of the exchange markets and information agencies for displaying in the specified fields of information about the current quotations, positions and calculation of profit and loss for each transaction. Thus, the unit also displays positions and has a feature of input of the price for a rate (point) change and a position amount through the keyboard.

Thus the following additions are applicable, for example:
to simplify access to the terminal and transfer of the amount into the trading account of the clients it is additionally equipped with the dactyloscopic (fingerprint) control and authentication system.
to manage the terminal, it can be additionally equipped with a voice control system.

The specified features are interconnected with development of a set of essential features, sufficient to receive the desired technical result.

The present invention is explained by a specific case of execution which, however is not unique, but visually demonstrates possibility of achievement of demanded technical result.

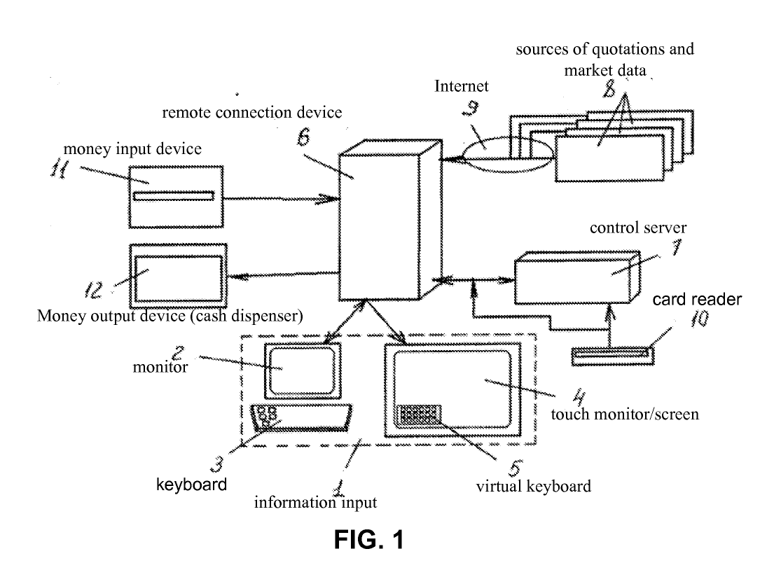

FIG. 1 shows the terminal of an exemplary embodiment. The remote communication terminal for trading on the exchange includes information input 1 and a reading device in the form of a monitor 2 and a push-button or touch keyboard 3 or a touch monitor 4 with a keyboard 5 on a monitor screen, a remote connection device 6 in the form of the programming and computing unit capable of displaying of the graphic interface with fields for showing target information. The present programming and computing unit is connected on the one side with the relevant control server 7 or the user's account state, for example the bank issuing a payment, (for example, credit and financial) card if the access to the trader's account is provided through the card, and on the other side with a source(s) 8 of quotations and other exchange information, such as Reuters, Bloomberg, Tenfore, and trading centers providing access to the trade operations on the FOREX market on the Internet 9).

Also, the terminal comprises, for example, a financial and credit card reader 10, directly or through a device 6 connected with the control server 7 for the user's account state.

The terminal also comprises a money input device 11 and a money output device 12 that allows to pay for the market position and to receive a profit at the place of the terminal location. The device 11 can be in the form of a unit built into the terminal case, or located outside the latter at a distance and connected with the programming and computing unit. This unit can have not only features of transfer of funds to the user's account, but also of withdrawing money from the user's account and/or outputting of the money. Such construction allows to use various mechanisms of account crediting and to use:

1) proximity cards (which work on the principle of credit cards, but to withdrawal the funds it is necessary just to bring the card to the device (to rest or bring to a distance of not more than 10 cm)

2) Payments by means of a telephone set:
Work on the principle of a proximity card if a phone has the necessary capability;
Gives commands to withdrawal from the account by means of SMS or special program on a phone;
A special bar code is sent to the phone which is read by the scanner of the organizer (on a terminal, in the organization's payment office);
A bar code of an item is read by a phone camera then the amount is automatically withdrawn.

3) Electronic payment systems. It is possible to provide access from the gambling terminal directly to the trader account registered in one of the payment systems for:
One-time transfer of specific amount to the trader's gambling account.
Issuing of a permit to the gambling system given results of a game session to automatically withdraw or transfer money from/to electronic payment system account.

4) Account and password in the sponsoring organization. To access credit, make withdrawal from the gambling account the personal client's account and password, or only the password is used:
One-time account (registered in the organization's payment office just before a game)
Permanent account (registered in the organization, on a site, during purchase of a special card; money can be transferred through the payment systems on site or in cash in the organization's payment office)

5) Cash and card reader: on the terminal, in the organization's payment office.

6) Scratch cards (issued with the fixed face value (a 500-roubles card, or a $20 card, a code field is rubbed, a code is entered to the device).

Thus, the terminal has the following capabilities:

1) Input of money to the game system by means of various devices (installed both in each separate device and only in the organization's payment office):
cash acceptor/dispenser;
magnetic card reader (card reader);
proximity cards and devices reader;
bar code reader;
other acceptable devices.

2) Input of money to the game system without use of additional input-output devices:
by means of electronic payment systems (WebMoney, Yandex money, etc.)
use of special software (such as banking software) on a mobile phone (mobile banking, bar code reading by a phone camera, etc.), entering of a special password (scratch cards).

The programming and computing unit has a remote connection with the server of the exchange and information agencies for displaying on the monitor's screen in the specified fields information about the current quotations, positions and calculation of profit and loss for each transaction. The unit can also display the positions made, with a feature of input of the price for a rate (point) change and a position amount through the keyboard and transfer of a premium to the account of a credit and financial card holder or output of a premium through a money output device.

To simplify access to the terminal and transfer of the amount into the trading account of the clients it is additionally equipped with the fingerprint control and authentication system. To manage the terminal the latter is additionally equipped with a voice control system. These terminal features allow verification of the user's identity.

During a session a client chooses a trade transaction (for example—a currency pair) and cost of at least one minimum price change for this trade transaction. Next,

What is claimed is:

1. A remote communication terminal for trading on exchange markets, the terminal comprising:
a monitor and a keyboard coupled to the monitor;
a device connected to the terminal for transfer of funds to user's account and withdrawal of funds from the user's account;
a device for dispensing money electronically coupled to the terminal and integrated into the terminal;
a device for remote connection in a form of the programming and computing unit configured to display a graphical interface including fields for showing target information, the device for remote connection being connected to control server for communicating a state of the user's account; and
means for transferring funds to the user's account and withdrawal of funds from the user's account and for dispensing money, integrated into the terminal and connected to the programming and computing unit for connection with servers of the exchange markets and sources of market information for displaying in information about user's current quotations, positions and calculation of profit and loss for each transaction of the user,
wherein the terminal displays changes in the user's positions on the monitor.

2. The terminal of claim 1, further comprising software installed on the terminal for enabling transfer and withdrawal of funds to/from the user's account.

3. The terminal of claim 1, further comprising a fingerprint reader integrated into the terminal for verifying the user's identity.

4. The terminal according to claim 1, further comprising a voice control system for receiving commands from the user.

5. The terminal according to claim 1, further comprising means for displaying 3-D images on the monitor.

6. A remote communication terminal for trading on exchange markets, the terminal comprising:
a touch screen monitor and a virtual keyboard displayed on the monitor;
a device connected to the terminal for transfer of funds to user's account and withdrawal of funds from the user's account;
a device for dispensing money electronically coupled to the terminal and integrated into the terminal;
a device for remote connection in a form of the programming and computing unit configured to display a graphical interface including fields for showing market information, the device for remote connection being connected to control server for communicating a state of the user's account; and
means for transferring funds to the user's account and withdrawal of funds from the user's account and for dispensing money, located a distance from the terminal and connected to the programming and computing unit for connection with servers of the exchange markets and sources of market information for displaying in information about user's current quotations, positions and calculation of profit and loss for each transaction of the user.
